(19) United States
(12) Patent Application Publication
(10) Pub. No.: US 2015/0050828 A1
(43) Pub. Date: Feb. 19, 2015

(54) ELECTRICAL CONNECTOR FOR USE WITH MODULE

(71) Applicant: HON HAI PRECISION INDUSTRY CO., LTD., New Taipei (JP)

(72) Inventors: GUANG-LEI XU, Kunshan (CN); ZHEN-HUA WANG, Kunshan (CN); WEI-TE CHUNG, San Jose, CA (US)

(21) Appl. No.: 14/461,351

(22) Filed: Aug. 15, 2014

Related U.S. Application Data
(60) Provisional application No. 61/867,027, filed on Aug. 17, 2013.

(30) Foreign Application Priority Data
Sep. 27, 2013 (CN) 2013205987241

(51) Int. Cl. H01R 13/627

(52) U.S. Cl. CPC H01R 13/6271
USPC 439/350

(57) ABSTRACT

An electrical connector comprises an insulative housing with a plurality of passageways to receive corresponding contacts, respectively. Each of the contacts includes a contact arm, a soldering portion and an engagement portion. The contact arm defines a contact point at an end thereof The engagement defines a first connecting rod, a second connecting rod and a joint section. The contact arm is above the first connecting rod and connects to one end of the first connecting rod. The first connecting rod defines a connecting face facing to the contact arm. The soldering portion connects with the second connecting rod. The joint section has a retaining arm extending along the direction far away from the first connecting rod. The retaining arm is disposed between the first and the second connecting rods and is lower than the connecting face of the first connecting rod.

### BACKGROUND OF THE INVENTION

1. Field of the Invention

The present invention generally relates to an electrical connector mounted upon the printed circuit board for use with a memory module which is adapted to be inserted into the connector at an angle, and further particularly to a contact used for the electrical connector so as to increase the power and signal transmission distance.

2. Description of Related Art

In the existing technology, a contact used for an electrical connector comprises a contact arm, a soldering portion and a retaining portion extending outwardly from a joint portion between the contact arm and the soldering portion. The contact arm has a contact point at one end thereof far away from the joint portion. The soldering portion has a connecting leg at one end thereof far away from the joint portion. The signal or power transmits from the contact point to the connecting leg via the contact arm and the soldering portion one by one or from the reverse path. However, with the continuous development of the electronic products, the high frequency signal transmission needs higher quality requirement. According to our research, the length differences of the transmission pathes of a pair of differential contact may cause a poor transmission quality.

In view of the foregoing, a contact with a special structure can improve the quality of the high frequency signal would be desirable.

### SUMMARY OF THE INVENTION

Accordingly, an object of the present invention is to provide an electrical connector for use with a module and the corresponding contacts used with the electrical connector, wherein the contact increases a signal transmission distance so as to improve a quality of the signal transmission.

In order to achieve the object set forth, an electrical connector comprises an insulative housing with a plurality of passageways to receive corresponding contacts therein, each of the contacts including a contact arm, a soldering portion and an engagement portion connecting the contact arm with the soldering portion. The contact arm defines a contact point at an end thereof The engagement defines a first connecting rod, a second connecting rod opposite to and below the first connecting rod and a joint section connecting with them. The contact arm is above the first connecting rod and connects to one end of the first connecting rod far away from the joint section. The first connecting rod defines a connecting face facing to the contact arm. The soldering portion connects with the second connecting rod. The joint section has a retaining arm extending along a direction far away from the first connecting rod. The retaining arm is disposed between the first and the second connecting rods and is lower than the connecting face of the first connecting rod.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector with a plurality of contacts therein;

FIG. 2 is a perspective view of the contact in FIG. 1;

FIG. 3 is a front view of the contact in FIG. 2;

FIG. 4 is a cross sectional view of the electrical connector along line 4-4 in FIG. 1;

FIG. 5 is a perspective view of the electrical connector according to another preferred embodiment of the instant invention;

FIG. 6 is a perspective view of the electrical connector of FIG. 5 mounted to a printed circuit board with therein a module (shown in the broken lines) to show an additional latch secures a front edge of the module around the middle region; and

FIG. 7 is a bottom view of the electrical component with solder balls on the undersurface thereof wherein a region of the undersurface is not occupied by the solder balls according to another embodiment of the instant invention.

### DETAILED DESCRIPTION OF THE INVENTION

Reference will now be made in detail to the preferred embodiment of the present invention.

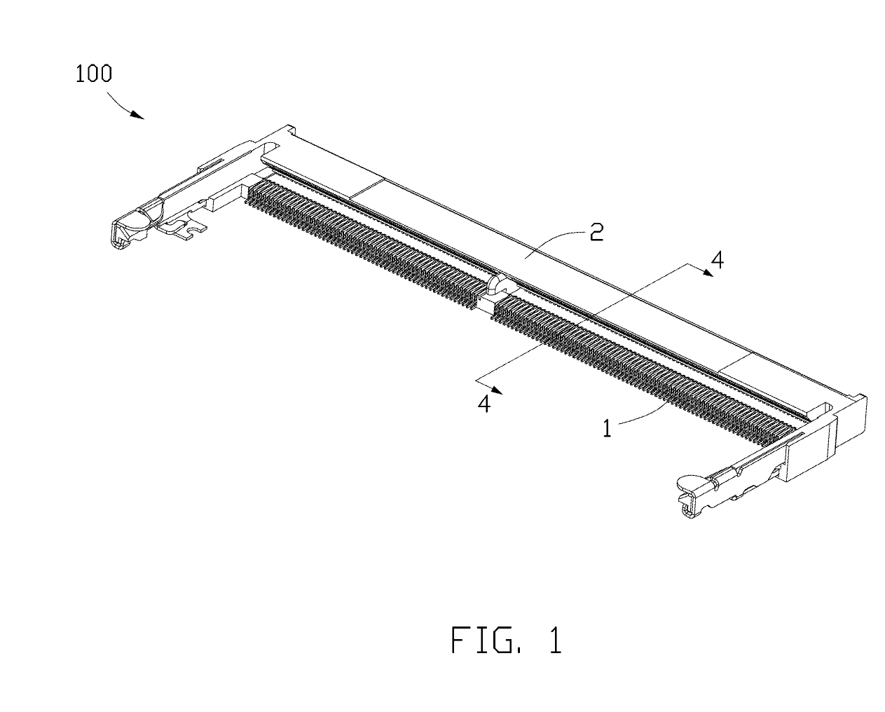

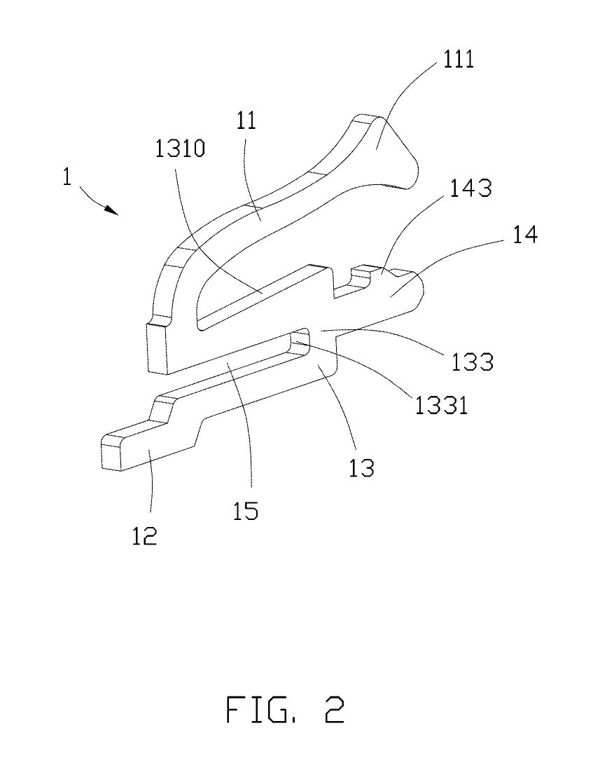

Referring to FIG. 1 and FIG. 2, the present invention provides an electrical connector 100 comprising a plurality of contacts 1 and an insulative housing 2 extending along a longitudinal direction. The contacts 1 is retained in the insulative housing 2 along longitudinal direction used for signal and power transmission.

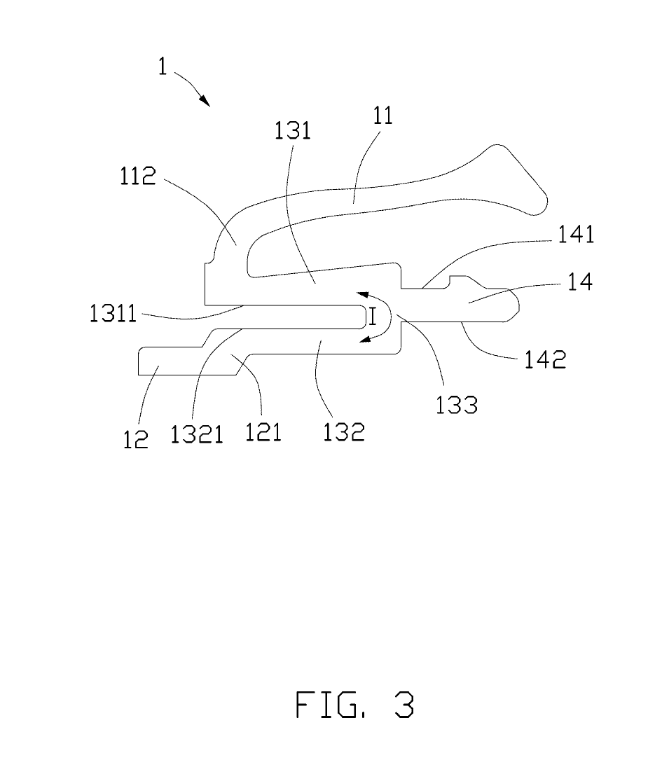

Referring to FIG. 2 and FIG. 3, each of the contacts 1 comprises a contact arm 11, a soldering portion 12 and an engagement portion 13 connecting the contact arm 11 with the soldering portion 12. The contact arm 11 defines a contact point 111 at a free end and an extending portion 112 at the other end opposite to the contact point 111. The extending portion 112 connects the contact arm 11 with the engagement portion 13. The soldering portion 12 has an inclined portion 121 connecting with the engagement portion 13. The soldering portion 12 further extends from the inclined portion 121 along a direction far away from the engagement portion 13.

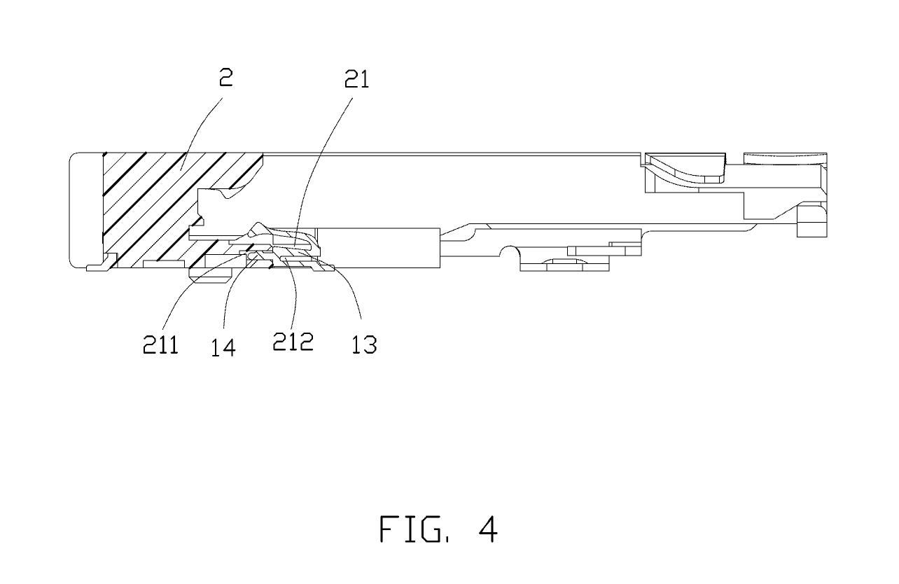

Referring to FIG. 3 and FIG. 4, in the present embodiment, the engagement portion 13 shown as U-shaped configuration comprises a first connecting rod 131, a second connecting rod 132 opposite to the first connecting rod 131 and a joint section 133 connecting the first connecting rod 131 with the second connecting rod 132. Two ends of the first and second connecting rods 131, 132 far away from the joint section 133 defining an opening 15 therebetween. That is to say, the first connecting rod 131, the second connecting rod 132 and the joint section 133 surround to form the opening 15 described aforementioned. The contact arm 11 is above the first connecting rod 131 and connects with the first connecting rod 131. The first connecting rod 131 defines a connecting face 1310 facing to the contact arm 11. Said soldering portion 12 connects with the second connecting rod 132. The engagement portion 13 defines a retaining arm 14 extending from the joint section 133 along a direction far away from the first connecting rod 131. The retaining arm 14 is disposed between the first and second connecting rods 131, 132 and lower than the connecting face 1310 of the first connecting rod 131.

Moreover, the width of the first connecting rod 131 increases from one end connecting with the contact arm 11 to another end connecting with the joint section 133. The second connecting rod 132 has a same width along a extending direction thereof In the present embodiment, the first and the second connecting rods 131, 132 are parallel to each other. Certainly, in other embodiments, the first and second connecting rods 131, 132 can be disposed in other states such as the first and the second connecting rods 131, 132 may bend along the extending direction thereof The joint section 133 defines a joint face 1331 facing to the opening 15. The first connecting rod 131 defines a first inner surface 1311 facing to the opening 15, and the second connecting rod 132 defines a second inner surface 1321 facing to the same opening 15. Said retaining arm 14 defines a first retaining face 141 and a second retaining face 142 opposite to the first retaining face 141. The retaining arm 14 defines a protruding portion 143 at the first retaining face 141 or the second retaining force 142. In the present embodiment, the first inner surface 1311 of the first connecting rod 131 is disposed between the first and the second retaining face 141, 142 of the retaining arm 14. The height of the first retaining face 141 is higher than the first inner surface 1311 of the first connecting rod 131. The height of the second retaining face 142 is higher than the second inner surface 1321 of the second connecting rod 132.

Referring to FIG. 4, the insulative housing 2 defines a plurality of terminal grooves 21 used for accommodating the contacts 1. Each of the terminal grooves 21 includes a retaining slot 211 and an accommodate room 212. The retaining arm 14 of the contact 1 retained in the retaining slot 211. The engagement portion 13 is accommodated in the accommodate room 212. Combined to FIG. 3, the retaining arm 14 is shorter than the first connecting rod 131 along an extending direction of the engagement portion 13.

In conclusion, the U-shaped engagement portion 13 forms an additional signal transmission path through the whole engagement portion 13. The signal and power can transmit from the contact point 111 to the soldering portion 12 via the contact arm 11, the first connecting rod 131 and the second connecting rod 132 one by one. The signal and power also can transmit in a reverse path opposite to the path aforementioned. The structure of the contact 1 increases the transmission distance for the signal and the power so as to efficiently reduce the impact of the different transmission distance of different contacts, thereby improving the quality of the signal transmission, especially benefit to the high frequency signal transmission.

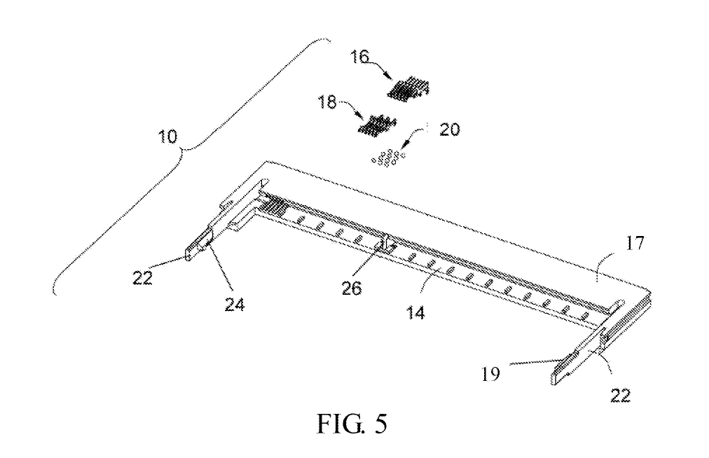

FIG. 5 to FIG. 7 will introduce another connector 10 with a module 50 mounted to a printed circuit board 200, and an additional latch 60 be provided to hold around a middle region of the front(outer) edge of the module 50 after the module 50 is rotated from the initial slanting position to the final horizontal position.

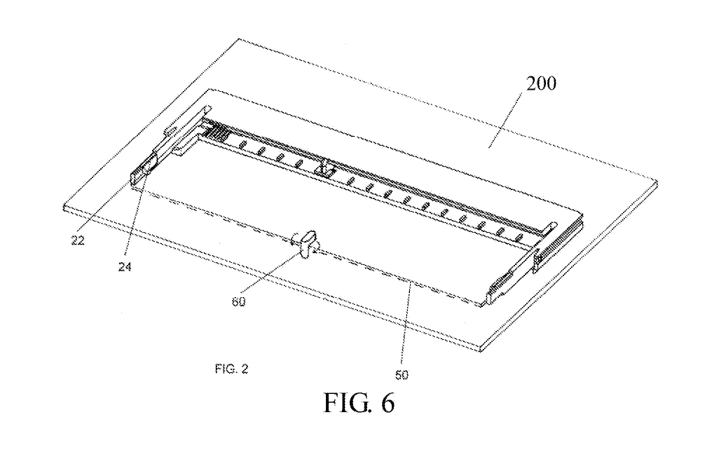

Referring to FIGS. 5 and 6, an electrical connector 10 includes an insulative housing 17 defining a receiving slot 19 along a longitudinal direction for receiving a memory module 50 therein. Upper row contacts 16 and lower row contacts 18 are located by two sides of the receiving slot 19 in a vertical direction perpendicular to said longitudinal direction wherein each contact is equipped with a solder ball 20 for surface mounting to a printed circuit board 200. A pair of latches 22 unitarily extend forwardly from two opposite ends of the housing in a front-to-back direction perpendicular to both the longitudinal direction and the vertical direction. Each of the latches includes a locking lug 24 for locking into the corresponding notch of the module 50 and downwardly pressing the corresponding side edge region thereabouts. An additional latch 60 is mounted upon the printed circuit board 200 and pivotal about an axis extending along the vertical direction so as to be located initially at an outer unlocking position for not interfering with the module 50 during rotating the module 50 from an initial slanted insertion position to a final horizontal position, and later rotated to an inner locking position where the locking head downwardly presses an outer/front edge region of the module 50 around the middle region in the longitudinal direction. Understandably, releasing the module 50 from the connector 10 is operated in a reversed way. The operation between the pair of side latches 22 and the module 50 is done as the traditional way.

Notably, the pair of plastic side latches 22 may be equipped with the corresponding metal reinforcement members or even replaced by the metal latches. Also, the additional latch 60 can be moveable in a linear way along the front-to-back direction, and even is immovably mounted upon the printed circuit board 200 while being adapted to be in a deflectable manner as operated by the side latch 22. Furthermore, the additional latch 60 may include the resilient structure/material on (an underside of) the locking head (not labeled) which extends horizontally and downwardly presses the module 50. On the other hand, the underside of the locking head may be provided with a guiding/wedged surface so as to ease confrontation between the locking head and the module 50 in the vertical direction when the additional latch 60 is moved from the outer unlocking position to the inner locking position.

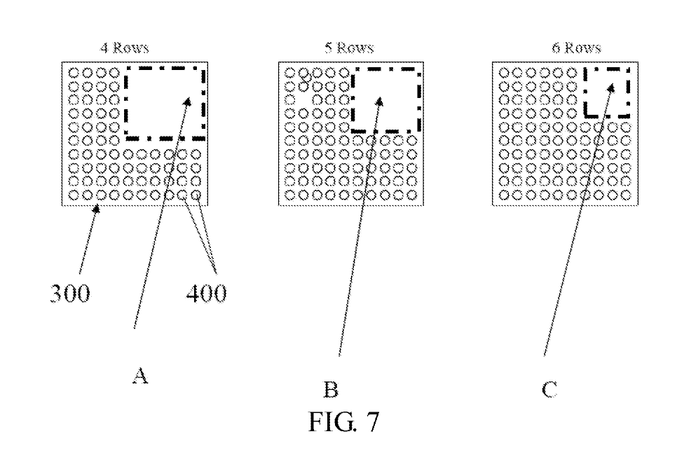

FIG. 7 shows an electronic component 300, such a package or connector, includes a plurality of solder balls 400 on the undersurface thereof in a matrix except some corner region A, B and C. To avoid tilting of the electronic component 300 during melting the solder balls 400 due to unbalanced arrangement thereof, or due to inadvertent external impact upon the electronic component 300 after soldering, a standoff structure (not shown) may be located upon the printed circuit board 200 or unitarily formed on an undersurface of the electronic component 300 in the corner region A, B and C to cooperate with the solder balls 400 to share the corresponding stress.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. An electrical connector comprising:
an insulative housing defining a plurality of passageways to receive a plurality of contacts therein,
each of said contact including
a contact arm defining a contact point at a free end thereof;
a soldering portion; and
an engagement portion connecting the contact arm with the soldering portion, the engagement portion defining a first connecting rod, a second connecting rod opposite to and below the first connecting rod and a joint section connecting with the two connecting rods, the contact arm located above the first connecting rod and connecting with one end of the first connecting rod far away from the joint section, the first connecting rod defining a connecting face facing to the contact arm, and the soldering portion connecting with the second connecting rod;
wherein the joint section has a retaining arm extending along a direction far away from the first connecting rod, the retaining arm is disposed between the first and the second connecting rods and is lower than the connecting face of the first connecting rod.

2. The contact as claimed in claim 1, wherein the retaining arm is shorter than the first connecting rod.

3. The contact as claimed in claim 1, wherein a width of the first connecting rod increases from one end thereof connecting with the contact arm to another end thereof connecting with the joint section, the second connecting rod has a same width along an extending direction thereof.

4. The contact as claimed in claim 1, further comprising an opening defined between the first and second connecting rods, the first connecting rod defines a first inner surface facing to the opening, and the second connecting rod defines a second inner surface facing to the same opening, the retaining arm defines a first retaining face and a second retaining face opposite to the first retaining face, the first retaining face is higher than the first inner surface of the first connecting rod, and the second retaining rod is higher than the second inner surface of the second connecting rod.

5. The contact as claimed in claim 4, wherein the first inner surface of the first connecting rod is disposed between the first and second retaining face of the retaining arm.

6. The contact as claimed in claim 4, wherein the first and second connecting rods are parallel to each other.

7. The contact as claimed in claim 4, wherein the first and second connecting rods may bend along their extending orientation.

8. The contact as claimed in claim 3, wherein the contact is assembled to an insulative housing extending along a longitudinal orientation, the insulative housing defines a terminal groove used for accommodating the contact.

9. The contact as claimed in claim 8, wherein the terminal groove includes a retaining slot and an accommodate room, the retaining arm of the contact is retained in the retaining slot, and the engagement portion is accommodated in the accommodate room.

10. An electrical connector assembly comprising:
a printed circuit board;
an electrical connector including:
an insulative housing mounted upon the printed circuit board and defining a receiving slot along a longitudinal direction;
upper and lower rows of contacts disposed by two sides of the receiving slot, in a vertical direction perpendicular to said longitudinal direction, with contacting sections extending into the receiving slot;
a pair of side latches extending forwardly from two opposite longitudinal ends of the housing in a front-to-back direction perpendicular to both said longitudinal direction and said vertical direction;
an additional latch mounted upon the printed circuit board; and
a memory module received in the housing with an inner edge retainably upwardly received in the receiving slot, two lateral edges downwardly held by the corresponding side latches, and an outer edge downwardly held by the additional latch.

11. The electrical connector assembly as claimed in claim 10, wherein the additional latch is configured to be moved to an inner locking position and an outer unlocking position in a self-free-standing manner.

12. The electrical connector assembly as claimed in claim 10, wherein said module is inserted into the housing at an angle in an initial oblique position and successively rotated to a final horizontal position to be latched by the side latches and the additional latch.

13. The electrical connector assembly as claimed in claim 12, wherein each of the lower row of contacts includes a lying U-shaped structure with opposite upper and lower connecting rods spaced from each other and a joint section therebetween, a retaining arm extending forwardly and horizontally from a middle portion of the joint section, a contacting arm forwardly and obliquely extending from a rear end section of the upper connecting rod, and a downwardly offset soldering portion extending rearward from a rear end section of the lower connecting rod.

14. The electrical connector assembly as claimed in claim 13, wherein the upper connecting rod defines a tapered structure with a less width around said rear end section.

15. The electrical connector assembly as claimed in claim 13, wherein a length of said upper connecting rod or said lower connecting rod is twice that of the joint section.

16. The electrical connector assembly as claimed in claim 13, wherein a length of said retaining arm is two thirds of that of the upper connecting rod or that of the lower connecting rod.

17. An electrical connector assembly comprising:
an insulative housing defining a receiving slot along a longitudinal direction, and upper and lower rows of passageways by two sides of the receiving slot in a vertical direction perpendicular to said longitudinal direction, said receiving slot forwardly communicating with an exterior in a front-to-back direction perpendicular to both said longitudinal direction and said vertical direction;
a plurality of contacts disposed in the corresponding passageways, respectively, each of said lower row of contacts including:
a U-shaped main body, in a lying manner, including an upper connecting rod, a lower connecting rod spaced from the upper connecting rod in the vertical direction, and a joint section therebetween;
a retaining arm extending horizontally from a middle portion of the joint section away from both said upper connecting rod and said lower connecting rod;
a contacting arm extending forwardly and obliquely from a rear end section of the upper connecting rod; and
a downward offset soldering portion extending rearward from a rear end section of the lower connecting rod.

18. The electrical connector assembly as claimed in claim 17, wherein the upper connecting rod defines a tapered structure with a less width around said rear end section.

19. The electrical connector assembly as claimed in claim 17, wherein a length of said upper connecting rod or said lower connecting rod is twice that of the joint section.

20. The electrical connector assembly as claimed in claim 17, wherein a length of said retaining arm is two thirds of that of the upper connecting rod or that of the lower connecting rod.
